(19) United States
(12) Patent Application Publication
(10) Pub. No.: US 2003/0120512 A1
(43) Pub. Date: Jun. 26, 2003

(54) Internet-based integrated healthcare delivery process and model

(76) Inventor: William C. Dengler, Rocky Mount, NC (US)

Correspondence Address: Adams, Schwartz & Evans, P.A., 2180 Two First Union Center, Charlotte, NC, 28282, US

(21) Appl. No.: 10/027,073

(22) Filed: Dec. 20, 2001

(51) Int. Cl. G06F 17/60

(52) U.S. Cl. 705/2

(57) ABSTRACT

A computer-driven information management system for coordinating delivery of healthcare services to patients via a communications network, including a server with a database configured to receive and store for retrieval data representing information regrading a patient and collected by a coordinating party from an information source. Data entry means permit the coordinating party to enter the data into the database. A computer communicates with the database via the communications network for processing the data using software downloaded to the server. This permits a requesting party selected from the group consisting of the coordinating party, the patient, a healthcare provider, and an individual authorized to access the data to use the data coordinate a plan of care for the patient related to treatment of at least one medical condition. A display device displays the data.

### TECHNICAL FIELD AND BACKGROUND OF THE INVENTION

This invention relates to a process and model for providing ongoing medical care to a patient to treat a medical condition. While the particular embodiment of the invention described in the application is shown being used to treat patients who suffer from gastroesophageal reflux disease, the invention has application in any healthcare setting where coordinating delivery of care from multiple healthcare providers is required to effectively treat a patient suffering from a chronic or other long-term condition (e.g., diabetes).

Gastroesophageal reflux disease (“GERD”) is a digestive disorder that affects the lower esophageal sphincter (“LES”). The LES is the muscle that connects the esophagus with the stomach, and is directly involved in causing the heartburn and acid indigestion experienced by many GERD sufferers. Also known as gastroesophageal reflux, heartburn or acid indigestion occurs when the LES is weak or relaxes, which in turn causes the acidic contents of the stomach to return back up into the esophagus. Persistent, recurring burning sensations and pain in the throat and upper thoracic region of a patient are the hallmark symptoms of GERD. If left untreated, GERD can lead to esophagitis, which may cause esophageal bleeding or ulcers. Other GERD suffers are also at risk for Barrett's esophagus (severe damage to the lining of the esophagus), which is considered a precursor to esophageal cancer.

Prior art methods for treating GERD offer an inadequate approach to providing care that results in duplicitous tests and physician referrals, difficult-to-access medical records, short-term remedies that provide patients no significant, extended relief from the disease. The treatment of GERD has traditionally been fragmented among many medical disciplines, including but not limited to primary care medicine, gastroenterlogy, surgery, and pulmonology. Physicians practicing in each of these disciplines will typically approach and render care to a GERD patient in a manner different from that which a physician practicing in another discipline would employ. Such physicians will also often provide care to the patient without consulting with other physicians who may have previously provided treatment. For example, a typical GERD patient will initially consult his or her primary care physician and receive a prescription for an anti-reflux medication. While the prescription may provide the patient temporary relief, it may also do more harm than good, as the temporary pain relief may deter the patient from pursuing care that could provide permanent resolution of the patient's GERD. In addition, many prescription medications for GERD must be taken continuously to provide sustained relief. Because they often lack knowledge of or access to alternative treatments for GERD, patients resorting to prescription medications often continue taking the medications for life. This is not only an expensive and cumbersome solution, but also one which may cause more serious symptoms that may require immediate treatment to be inadvertently masked. Furthermore, records dictated by the patient's primary care physician often remain stored in the physician's office, and thus cannot be readily accessed by other healthcare providers who may subsequently be called upon by the patient to provide relief from ongoing GERD symptoms.

The invention of the present application addresses the pitfalls associated with prior art methods of treating GERD and other chronic medical conditions by providing a unique system that integrates the delivery of healthcare services by multiple healthcare providers to a GERD patient so that the patient can receive comprehensive treatment for his or her condition without having to resort to self-management of what typically becomes a confusing maze of medical records, appointments, and treatment options. Using a multi-disciplinary approach, the present invention provides a comprehensive treatment center that coordinates the provision of medical services for the patient and results in a smooth progression of therapy for the patient's heartburn from the initial examination through medical, endoscopic and/or surgical therapies, if required. The system further utilizes a clinical coordinator who is involved in all aspects of the patient's care throughout the treatment process.

The present invention not only employs a centralized treatment center to coordinate patient medical care, but also utilizes a unique software program that further streamlines the process of integrating information relevant to treating the patient's GERD. In particular, the software uses Internet technology to enable data regarding all aspects of treatment of the patient to be stored in a central location, retrieved from that location, and holistically analyzed by the patient's healthcare providers. Unlike certain prior art systems having software that dictates to the user the type of medical care to be provided to the patient, the software of the present invention serves as a management tool for assimilating all medical records and information regarding the patient at a central location so that the healthcare providers may more efficiently utilize the records and information to make decisions regarding treatment for the patient. This not only eliminates time previously spent by providers tracking down test results and historical records, but also decreases the overall cost of providing care by significantly reducing the number of duplicitous tests, appointments, and data-collecting efforts that have predominated the prior art approach to treating GERD.

### SUMMARY OF THE INVENTION

It is therefore an object of the present invention to provide a system for coordinating streamlined and organized delivery of medical services from multiple healthcare providers to a single patient.

It is another object of the invention to provide a computerized information management system that is used in conjunction with a multi-disciplinary approach to patient care to provide comprehensive treatment of all aspects of a patient's gastroesophageal reflux disease.

It is another object of the invention to provide a comprehensive approach to treating a patient's medical condition that includes an information management system that employs Internet-based software which enables centralized storage of and access to medical records and other information originating from multiple, disparate sources, thereby permitting a holistic approach to treating a patient's condition.

It is another object of the invention to provide a Web site that permits an individual to download data from the Internet to a conventional computer for use in providing medical care to a patient.

It is another object of the invention to provide a system for providing comprehensive treatment of gastroesophageal reflux disease that utilizes a Web site to which access is restricted to specific individuals by using conventional information technology security measures for ensuring the integrity of the data available through the Web site.

It is another object of the invention to provide a system for treating a patient's medical condition that permits the patient to consult with and rely upon a single source for coordinating all aspects of medical care related to treatment of the condition.

These and other objects and advantages of the present invention are achieved in the preferred embodiment disclosed below by providing a computer-driven information management system for coordinating delivery of healthcare services to patients via a communications network. The system includes a server with a database configured to receive and store for retrieval data representing information regarding a patient and collected by a coordinating party from an information source. The system also includes data entry means permitting the coordinating party to enter the data into the database. A computer communicates with the database via the communications network for processing the data using software downloaded to the server. This permits a requesting party selected from the group consisting of the coordinating party, the patient, a healthcare provider, and an individual authorized to access the data to use the data to coordinate a plan of care for the patient related to treatment of at least one medical condition. The system also includes a display device for displaying said data.

According to one preferred embodiment of the invention, the communications network is a global communications network.

According to another preferred embodiment of the invention, the plan of care is a preselected event selected from the group consisting of an appointment with a healthcare provider, an outpatient procedure, and an inpatient procedure.

According to yet another preferred embodiment of the invention, the system includes access means cooperating with the communications network for permitting the requesting party to access the data from a remote location.

According to yet another preferred embodiment of the invention, the access means is a modem.

According to yet another preferred embodiment of the invention, the access means includes a Web site maintained by a system administrator and accessible by the requesting party for permitting the requesting party to enter the data into and retrieve the data from the database using the software.

According to yet another preferred embodiment of the invention, the access means includes a preselected password provided to the requesting party for selectively permitting the requesting party to access the Web site.

According to yet another preferred embodiment of the invention, the coordinating party is a healthcare provider or a registered nurse.

According to yet another preferred embodiment of the invention, the information source is the patient, the requesting party, or a healthcare provider.

According to yet another preferred embodiment of the invention, the display means is a screen.

According to yet another preferred embodiment of the invention, the screen is an LCD screen.

According to yet another preferred embodiment of the invention, the screen is a VGA monitor.

According to yet another preferred embodiment of the invention, the data entry means is a keyboard or a graphical user interface including a touch screen.

A preferred embodiment of a method of coordinating delivery of healthcare services to patients via a communications network according to the invention includes the step of providing a computer-driven information management system. The system has a server including a database configured to receive and store for retrieval data representing information regarding a patient and collected by a coordinating party from an information source. The system also includes a data entry device for permitting the coordinating party to enter the data into the database. A computer communicates with the database via the communications network for processing the data using software downloaded to the server. This permits a requesting party selected from a coordinating party, the patient, and an individual authorized to access the data to use the data to coordinate a plan of care for the patient related to treatment of at least one medical condition. A display device displays the data. The method also includes the steps of collecting the information regarding the patient from the information source, and entering the data representing the information collected from the information source into the database using the data entry device. The computer is used to process the data using the software, and the data is communicated to the requesting party.

According to one preferred embodiment of the method according to the invention, the communications network is a global communications network.

According to another preferred embodiment of the method according to the invention, the plan of care is a preselected event selected from an appointment with a healthcare provider, an outpatient procedure, or an inpatient procedure.

According to yet another preferred embodiment of the invention, the method includes the step of providing the requesting party access to the data.

According to yet another preferred embodiment of the method according to the invention, the step of providing the requesting party access to the data includes providing a modem cooperating with the communications network for permitting the requesting party to access the data from a remote location.

According to yet another preferred embodiment of the method according to the invention, the step of providing the requesting party access to the data includes providing a Web site maintained by a system administrator and accessible by the requesting party for permitting the requesting party to enter the data into and retrieve the data from the database using the software.

According to yet another preferred embodiment of the method according to the invention, the step of providing the requesting party access to the data also includes providing a preselected password to the requesting party for selectively permitting the requesting party to access the Web site.

According to yet another preferred embodiment of the method according to the invention, the coordinating party is selected from a healthcare provider or a registered nurse.

According to yet another preferred embodiment of the method according to the invention, the information source is the patient, the requesting party, or a healthcare provider.

According to yet another preferred embodiment of the method according to the invention, the display means is a screen.

According to yet another preferred embodiment of the method according to the invention, the data entry means is a keyboard or a graphical user interface including a touch screen.

According to yet another preferred embodiment of the invention, a computer readable medium is provided that includes software for coordinating delivery of healthcare services to a patient for treatment of at least one medical condition. The software provides instructions for configuring a database located on a server to receive and store for retrieval data representing information regarding a patient and collected by a coordinating party from an information source. The software also provides instructions for associating a data entry device with the database for permitting the coordinating party to enter the data into the database and for associating a computer with the data entry device and the database for processing the data. This permits a requesting party selected from the coordinating party, the patient, or an individual authorized to access the data to use the data to coordinate a plan of care for the patient related to treatment of at least one medical condition. The software also includes instructions for enabling the computer to cooperate with a communications network for permitting the requesting party to access the plan of care from a remote location, and for enabling a display device associated with the computer to display the data to the requesting party.

According to yet another preferred embodiment of the invention, another computer-driven information management system for coordinating delivery of healthcare services to patients via a communications network is provided. The system includes a server having a database configured to receive and store for retrieval data representing information regarding a patient and collected by a coordinating party from an information source, and a data entry device for permitting the coordinating party to enter the data into the database. A computer communicates with the database via the communications network for processing the data using software downloaded to the server for permitting a requesting party selected from the coordinating party, the patient, a healthcare provider, or an individual authorized to access the data to use the data to coordinate a plan of care for the patient related to treatment of at least one medical condition. The system further includes a display device for displaying the plan of care to the requesting party.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a diagram of an information management system according to one preferred embodiment of the invention;

FIG. 2 is a diagram of a configuration of components of the system shown in FIG. 1;

FIG. 3 is a partial view of a page of a Web site included in the system;

FIG. 4 is a diagram illustrating a patient initiating a treatment process using the system;

FIG. 5 is a representative sample of patient information collected using the system;

FIG. 6 is a screen shot of a page of the Web site included in the system;

FIG. 7 is a flowchart of the first part the treatment process performed by the system of the present invention;

FIG. 8 is a flowchart of the second part of the treatment process illustrated in FIG. 7;

FIG. 9 is a screen shot of another page of the Web site included in the system;

FIG. 10 is a screen shot of another page of the Web site included in the system;

FIG. 11 is a screen shot of another page of the Web site included in the system;

FIG. 12 is a screen shot of another page of the Web site included in the system;

FIGS. 13A and 13B show a representative sample of a patient plan of care included in the system;

FIGS. 14A and 14B show a representative sample of a physician plan of care included in the system;

FIGS. 15A and 15B show a representative sample of a test result summary included in the system;

FIG. 16 is a screen shot of another page of the Web site included in the system;

FIG. 17 is a screen shot of another page of the Web site included in the system;

FIG. 18 is a screen shot of another page of the Web site included in the system; and

FIG. 19 is a screen shot of another page of the Web site included in the system.

### DESCRIPTION OF THE PREFERRED EMBODIMENT AND BEST MODE

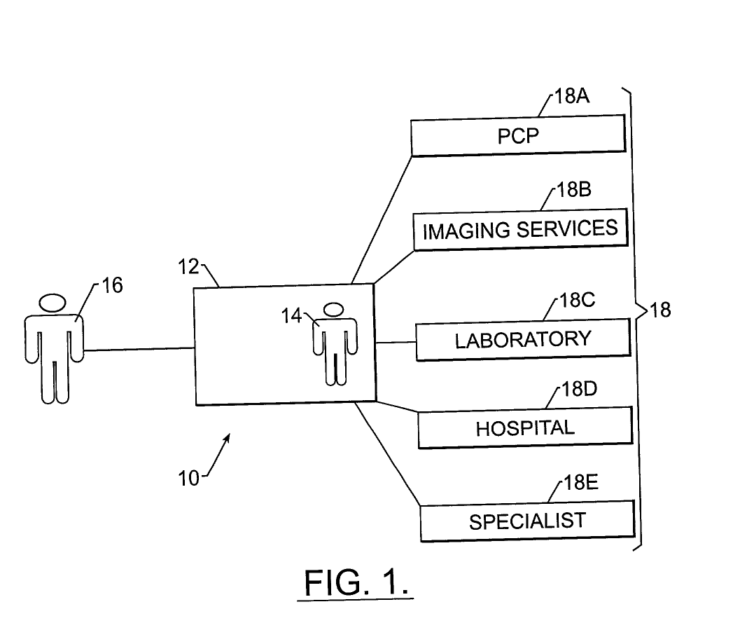

Referring now specifically to the drawings, an embodiment of the computer-driven information management system of the pre sent invention is illustrated in FIG. 1 and shown generally at reference numeral 10. The system 10 includes a treatment center 12 staffed by a coordinating party 14. The center 12 and coordinating party 14 exist to assist a patient 16 in scheduling and receiving care from one or more healthcare providers 18 that are associated with the center 12. Healthcare providers 18 include, but are not limited to, a primary care physician (“PCP”) 18A, an imaging services or radiology group 18B, a medical laboratory 18C, a hospital 18D and at least one medical specialist 18E, such as a gastroenterologist, surgeon, internist or pulmonologist.

With the exception of the physical space required to occupy the center 12, the system 10 is computer-based and utilizes pre-existing outpatient and inpatient healthcare facilities for providing care to the patient 16. Therefore, the system 10 requires minimal human resources and physical space to operate. While the treatment center 12 may be in any suitable location convenient to the patients and healthcare providers, the center 12 is preferably pre-existing office space in or near a hospital or other medical facility.

The day-to-day operation of the center 12 shown in FIG. 1 and organization of data used in conjunction with the system 10 is managed by the coordinating party 14. The coordinating party 14 is responsible for coordinating treatment of and collecting related data for any patient 16 who utilizes the system 10. Although the coordinating party 14 may be any suitable healthcare provider, the coordinating party 14 is preferably a Registered Nurse who has prior experience working with patients suffering from GERD. The coordinating party is also preferably an employee of the hospital or other medical facility in which the center 12 is located.

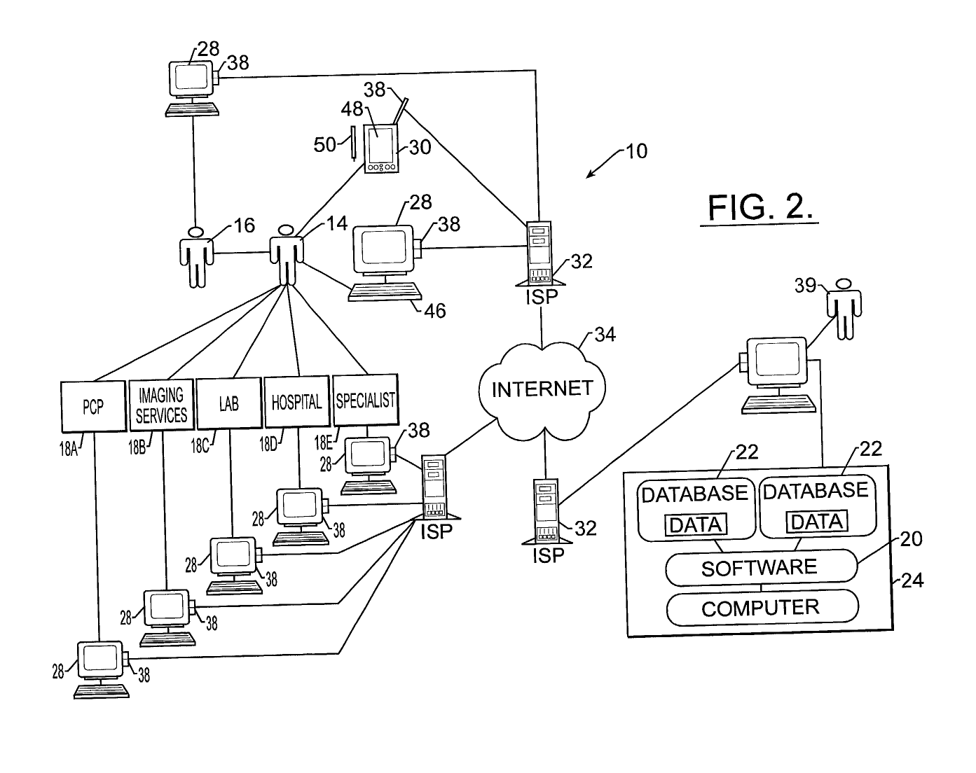

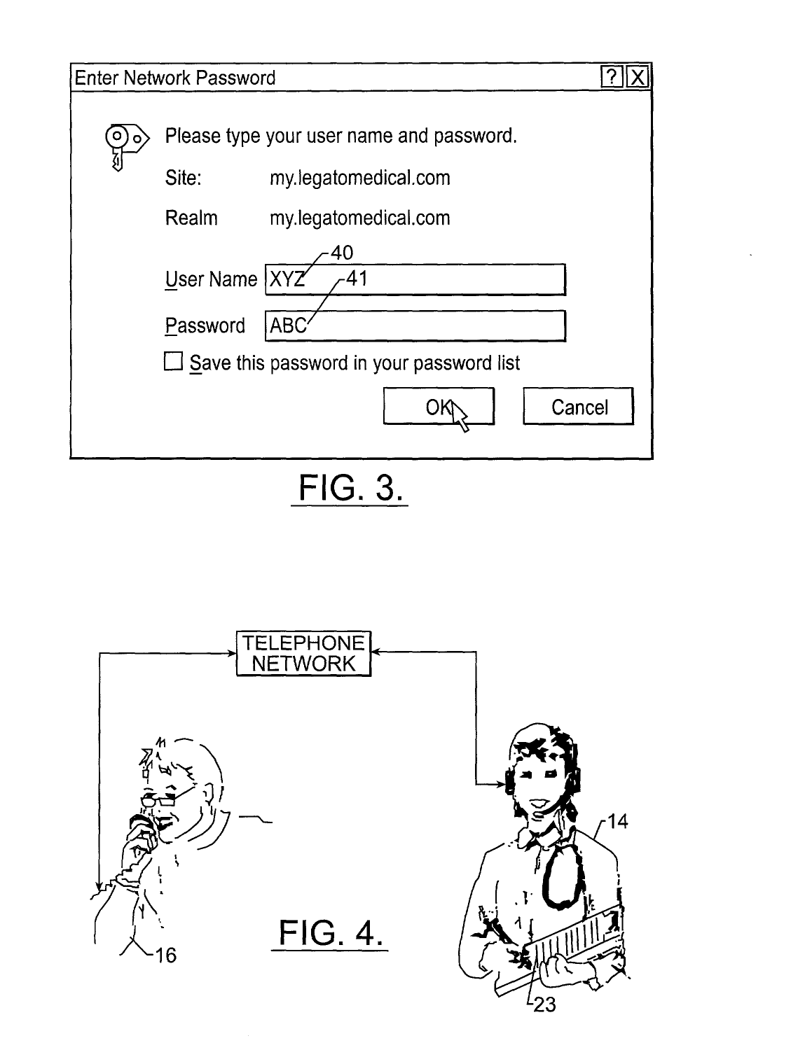

Referring now to FIG. 2, the system 10 also includes a software program 20 and one or more databases 22. The software program 20 and databases 22 reside on a computer server 24 and are accessed by the coordinating party 14 through a Web site 26 (see FIG. 6) using a standard personal computer 28 or personal digital assistant 30, one more Internet service providers (“ISPs”) 32, the Internet 34, and standard communications equipment 38. The standard communications equipment 38 includes, but is not limited to, a modem, a wireless communications device, or any other suitable device capable of establishing an Internet connection. The server 24, software program 20 and Web site 26 are maintained by a system administrator 39. The software program 20 enables the coordinating party 14 to collect, coordinate and retrieve data relating to medical treatment for the patient 16 which may then be provided to one or more of the healthcare providers 18 (see FIG. 1) to assist in coordinating the delivery of medical care to the patient 16. As is shown in FIG. 2, the databases 22 may alternatively be accessed by the patient 16 and the providers 18A-18E using standard personal computers 28 and conventional Internet accessing techniques. As is shown in FIG. 3, access to the Web site 26 and databases 22 is controlled using conventional security techniques, including but not limited to assigning a unique user name 40 and password 41 to the coordinating party 14, the patient 16, each provider 18A-18E, and the system administrator 39.

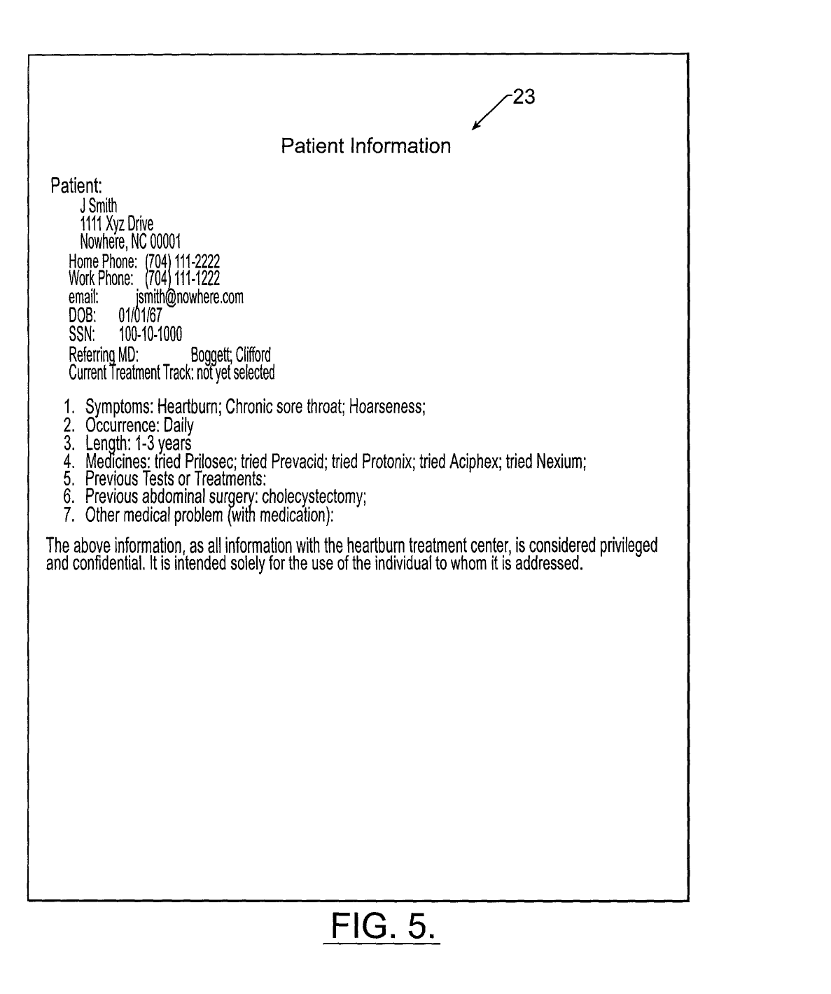

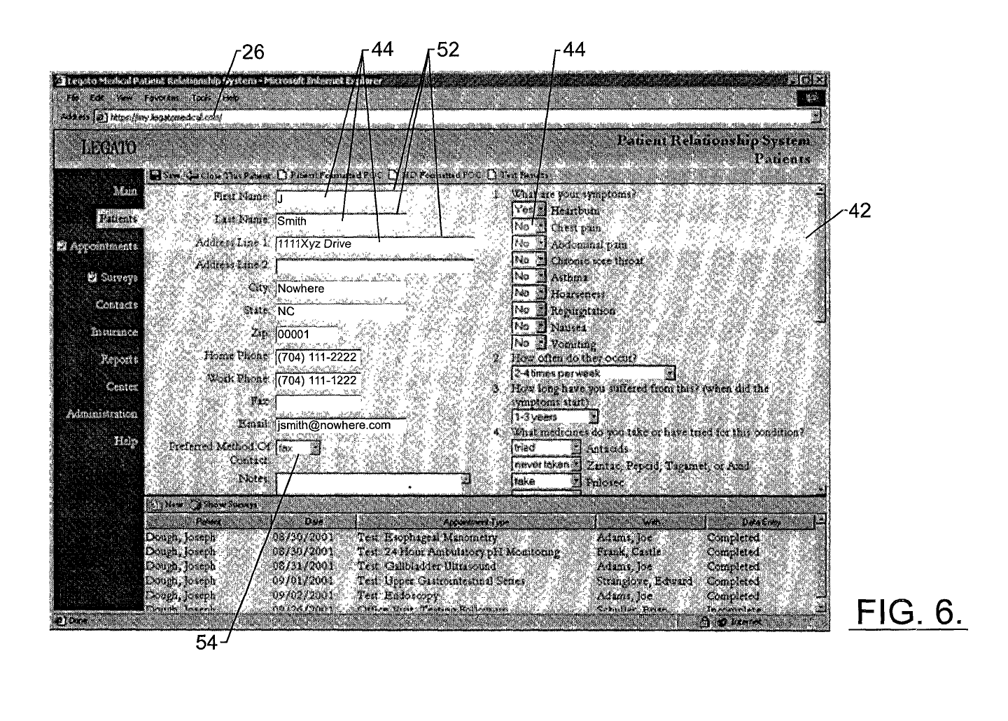

Referring now to FIGS. 4 through 19, the manner in the system 10 is used to collect and organize data regarding the patient 16 is shown. As is shown in FIG. 4, to begin receiving treatment through the center 12 using the system 10, the patient 16 first initiates contact with the coordinating party 14. The coordinating party 14 then interviews the patient 16 to collect specific information 23 regarding the patient 16, including but not limited to demographic information and a medical history containing a description of the patient's symptoms and any treatment previously received. Although the patient 16 is shown in FIG. 4 initiating contact by telephone, the patient 16 may alternatively contact the coordinating party 14 through a personal computer using conventional Internet and e-mail techniques, or be referred to the center 12 by a primary care or other physician. A representative sample of information 22 collected from a patient 10 is shown in FIG. 5.

Referring now to FIG. 6, the manner in which the software program 20 shown in FIG. 2 is utilized to collect and organize data related to the patient 16 is illustrated. FIG. 6 is a screen shot of an initial patient survey page 42 included on the Web site 26. The survey page 42 is generated using the software program 20, and captures textual information data 44 representing the identity, symptoms and treatment history of the patient 16 as collected by the coordinating party 14 during the interview. Using a keyboard 46 connected to the computer 28 or alternatively, the touch screen 48 and stylus 50 of the personal digital assistant 30 shown in FIG. 2, the coordinating party 14 enters the textual information data 44 into corresponding data entry fields 52 on the survey page 42 shown in FIG. 6. The initial patient survey page 42 also includes a method of contact entry field 54 in which data is entered to reflect whether the patient 16 prefers to be contacted by e-mail, facsimile, mail, or telephone. Referring again to FIG. 2, data 44 recorded on the survey page 42 is then downloaded to and stored in one of the databases 22 on the server 24.

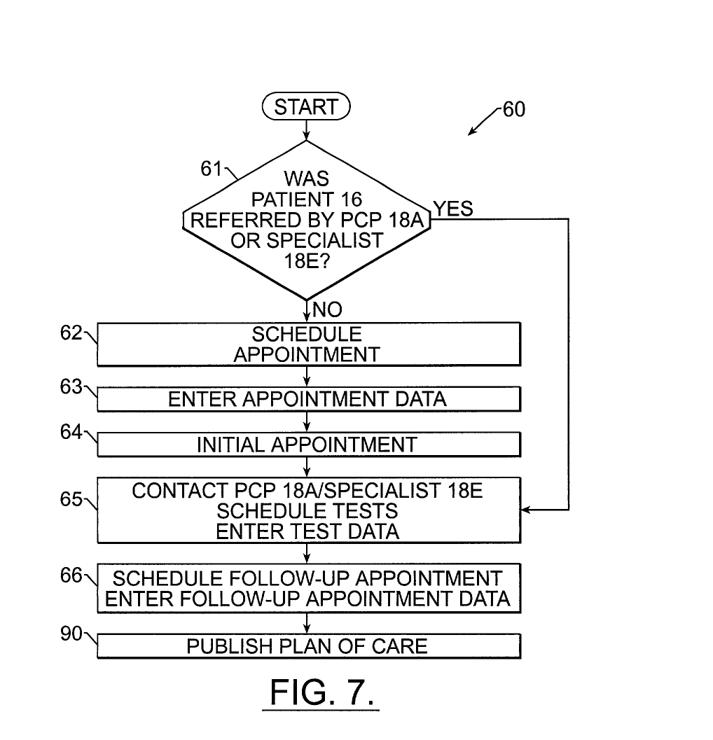

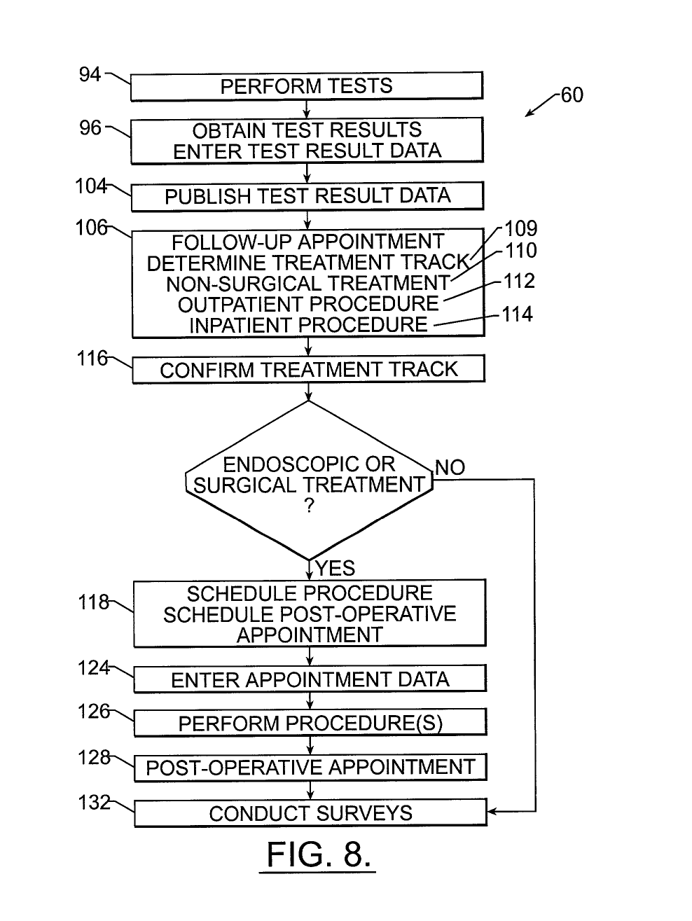

Once the profile for the patient 16 has been established, the software program 20 is utilized to schedule and manage a treatment process 60 for the patient 16. FIGS. 7 and 8 depict flowcharts illustrating the treatment process 60. As is shown in FIG. 7, upon completing the initial interview with the patient, the coordinating party 14 determines whether the patient 16 was referred to the center by one of the primary care physicians 18A or specialists 18E associated with the center 12 (step 61). If the patient 16 was referred to the center 12 in this manner, the coordinating party 14 contacts the referring PCP 18A or specialist 18E and proceeds directly to step 65, which is described in greater detail below. However, if the patient was not referred by a PCP 18A or specialist 18E, the coordinating party 14 proceeds to step 62 and schedules an appointment with a PCP 18A or specialist 18E for the patient 16. As depicted at step 63, the coordinating party then enters textual information data representing the scheduled appointment (“appointment data”) into corresponding data entry fields on an appointment page that is similar to the initial patient survey page 42 described above with reference to FIG. 6. Like the textual information data 44, the appointment data is stored and downloaded to one of the databases 22 on the server 24.

The treatment process 60 then proceeds to step 64, in which the patient 16 meets with the PCP 18A or specialist 18E for the initial appointment. During the initial appointment, the PCP 18A or specialist examines the patient 16 and determines what diagnostic tests, if any, need to be performed. Those tests which are capable of being performed during the initial appointment are conducted at that time, and decisions are made regarding those tests to be performed by other healthcare providers 18 or by providers not affiliated with the center 12.

After the date of the initial appointment has passed, the software program 20 generates a reminder to the coordinating party 14 through the Web site 26 to prompt the coordinating party to execute step 65. Alternatively, if the patient 16 reported to the coordinating party 14 that he or she had been referred to the center 12 by a PCP 18A or specialist 18E, the coordinating party 14 proceeds directly to step 65. In particular, the coordinating party 14 contacts the PCP 18A or specialist 18E who conducted the initial appointment or otherwise met with the patient 16, and collects information regarding each of the diagnostic tests the PCP 18A or specialist 18E ordered or performed. The coordinating party 14 then contacts relevant healthcare providers 18 or other providers not associated with the center 12 on behalf of the patient 16, and schedules each of the diagnostic tests ordered by the PCP 16A or specialist 18E. The coordinating party 14 also schedules a follow-up appointment for the patient with the PCP 18A or specialist 18E who conducted the initial appointment (step 66). The follow-up appointment is scheduled on a date subsequent to the dates upon which the diagnostic tests are scheduled.

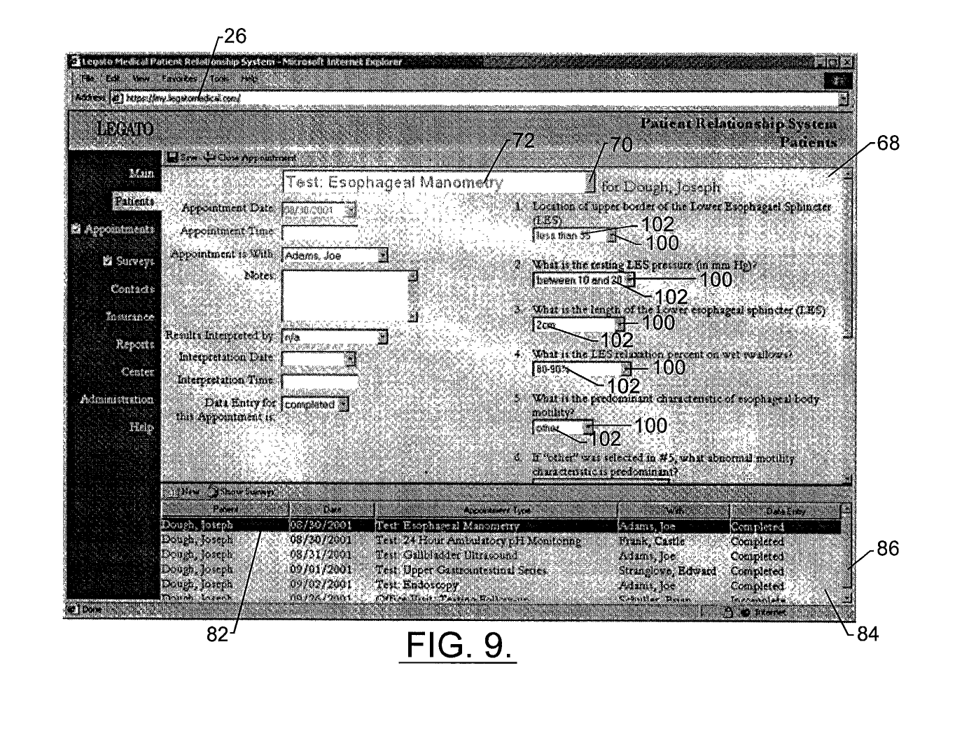

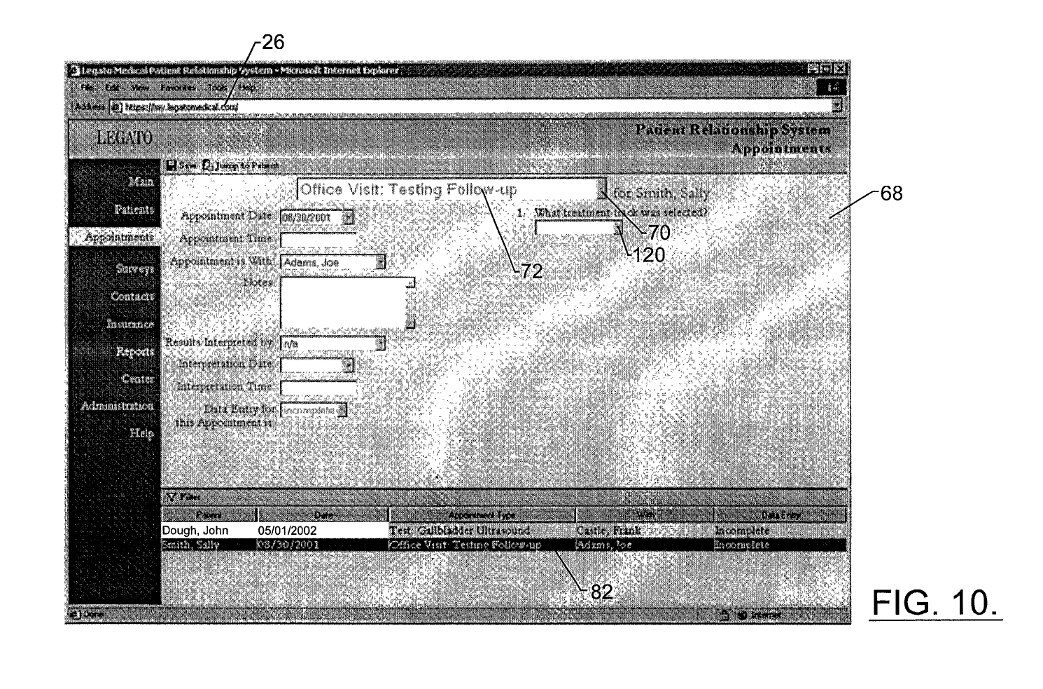

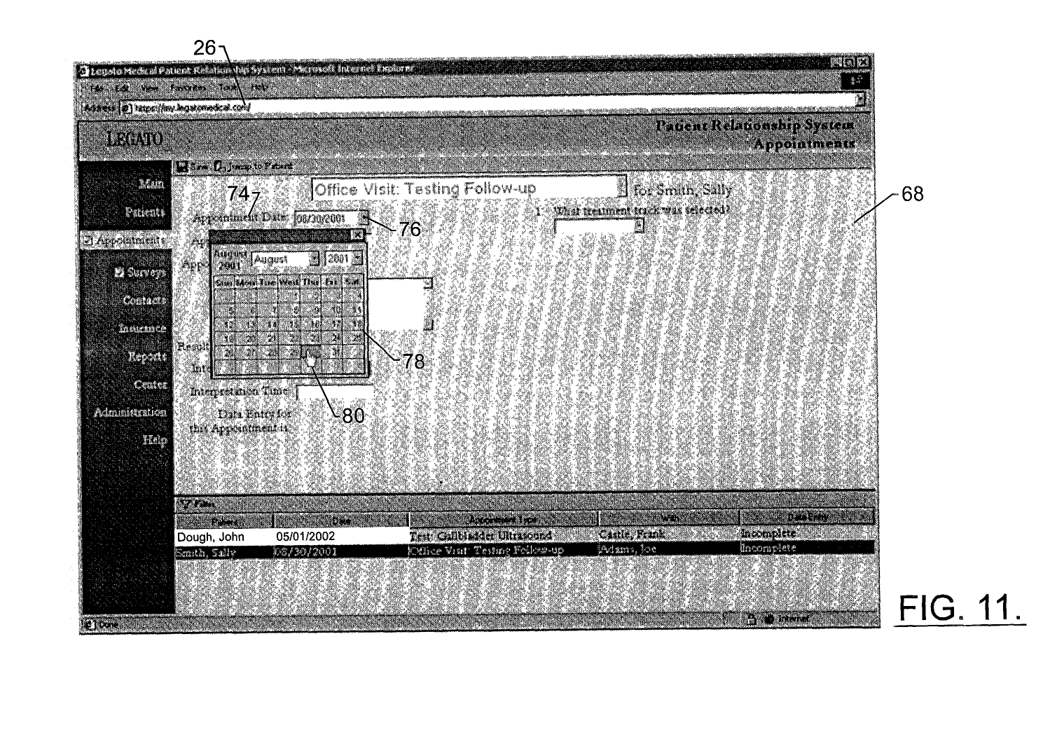

Referring now to FIG. 9, all information related to the appointments is recorded on the Web site 26. The software program 20 generates an appointment page 68 on the Web site 26, which is used by the coordinating party 14 to schedule an appointment and record data for each of the diagnostic tests. A new appointment page 68 is generated for each test and for the follow-up appointment. Using the appointment page 68 as a representative example, each appointment page 68 includes a pull-down menu 70 which the coordinating party 14 uses to select textual description data 72 representing the specific test or other appointment being scheduled. While the textual description data 72 selected in the pull-down menu 70 shown in FIG. 9 is for an esophageal manometry test, the textual description data 72 may alternatively represent any type of diagnostic test or other outpatient or inpatient procedure suitable for diagnosing or treating GERD. FIG. 10 depicts an example of an appointment page 68 in which the textual description data 72 selected from the pull-down menu 70 is for the follow-up appointment described above in reference to step 66 shown in FIG. 7.

Referring now to FIG. 11, each appointment page 68 includes additional data entry fields and pull-down menus for recording data related to the appointment time, appointment location, and test interpretation information. Specifically, as is shown in FIG. 11, each appointment page 68 includes an appointment date data entry field 74 in which a pull-down menu 76 appears opens into a calendar 78 upon which a cursor 80 may be positioned to “point-and-click” a preselected appointment date.

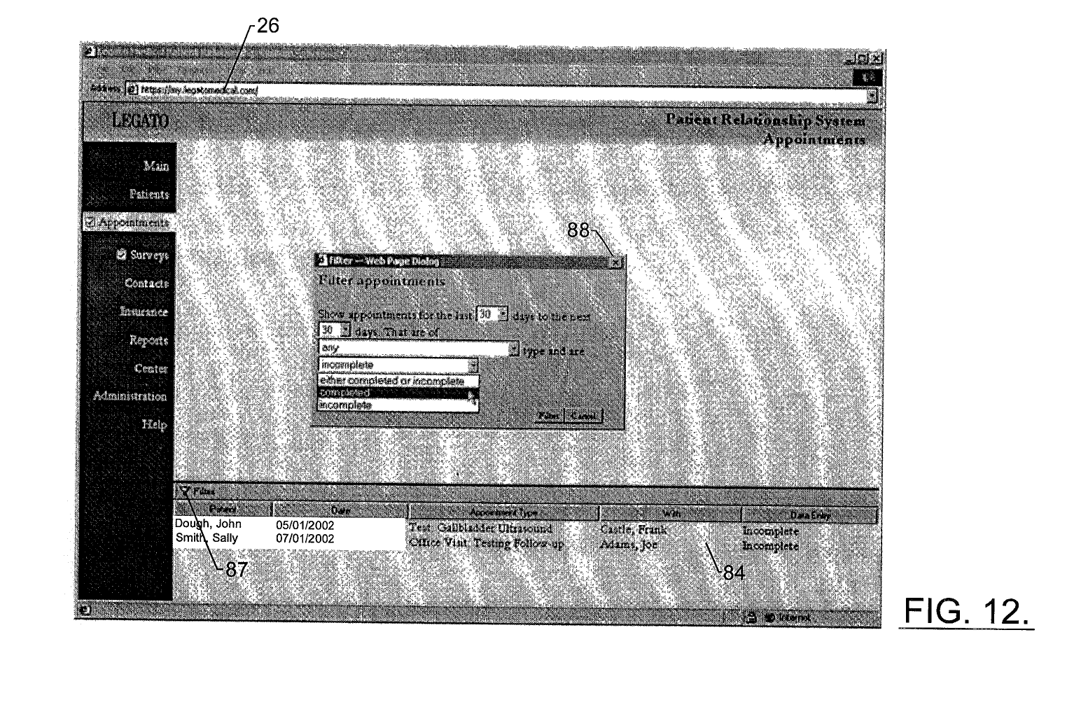

All data entered on each appointment page 68 is saved and downloaded to one of the databases 22 on the server 24 (see FIG. 2). Referring again to FIG. 10, once the data has been saved, an appointment 82 corresponding to the data appearing on a respective one of the appointment pages 68 appears with other scheduled tests and appointments in an appointment schedule 84. The schedule 84 is located in a window 86 positioned below the appointment page 68. Selecting and highlighting the appointment 82 listed in the appointment schedule 84 causes the corresponding appointment page 68 to appear above the schedule 84. As is shown in FIG. 12, the Web page 26 also includes a filter command 87 that opens a box 88 which allows the coordinating party 14 to define a group of appointments to appear in the schedule 84 based upon a particular time frame, the appointment type, and whether all data entry related to the appointment has been completed. The filter command 87 is available on every appointment page 68, and may also be used to select all or a portion of the scheduled appointments for any patient 16 entered into the system 10.

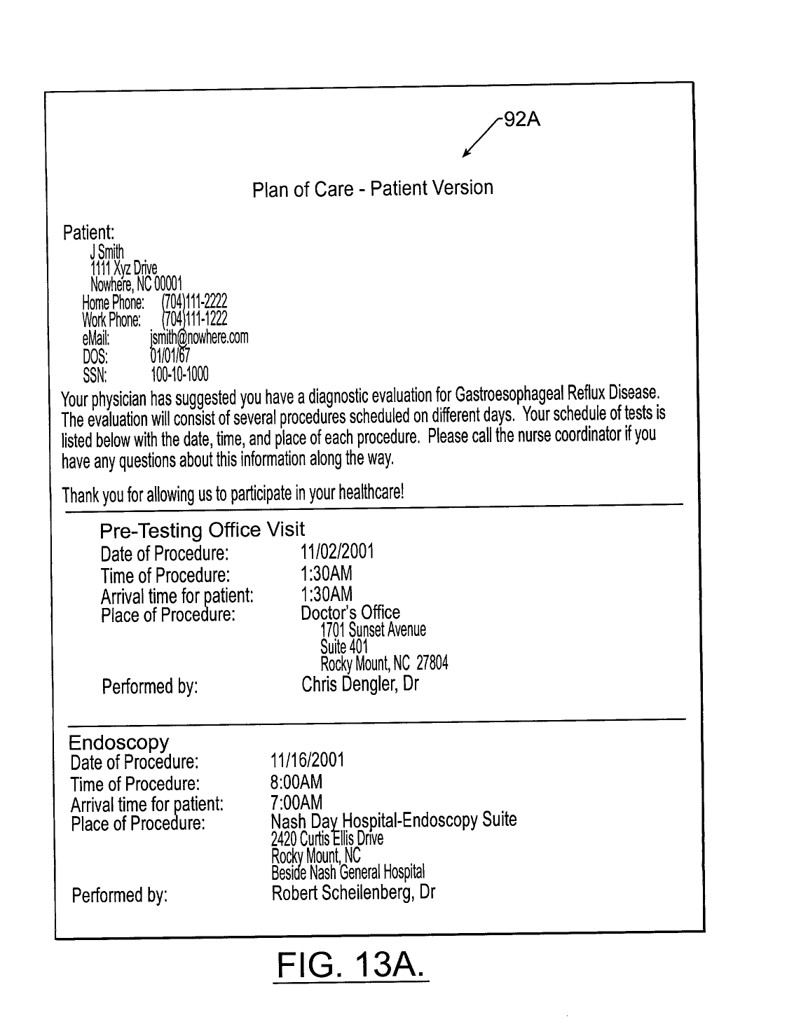

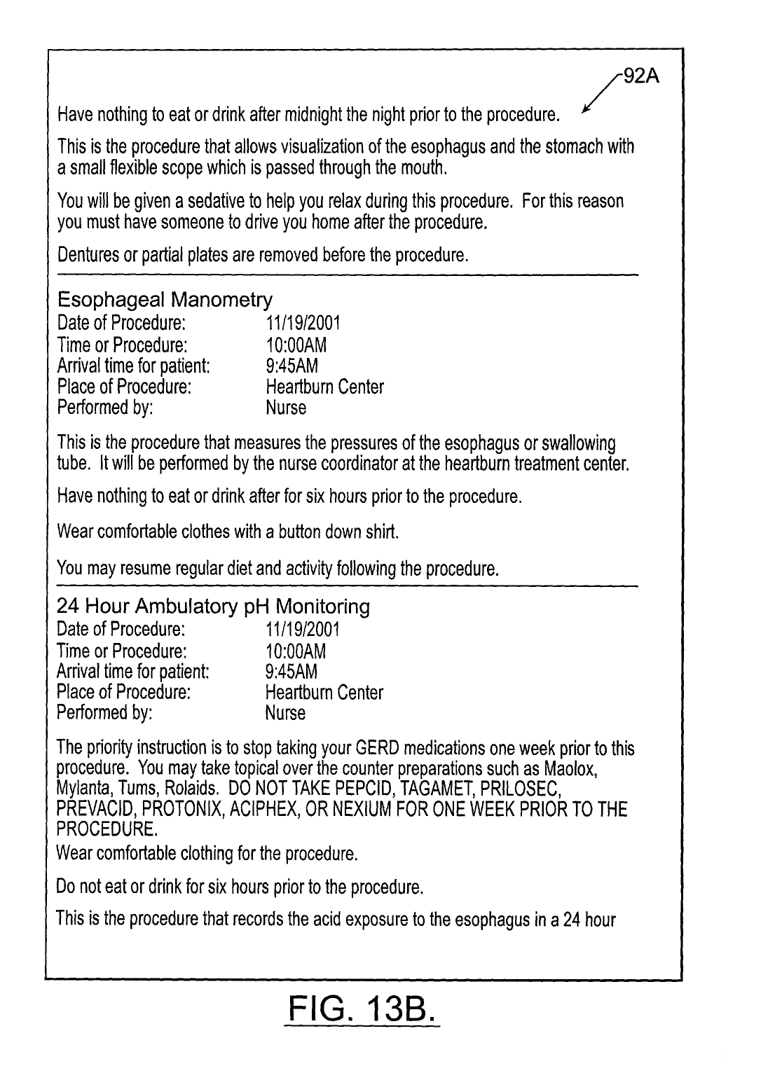

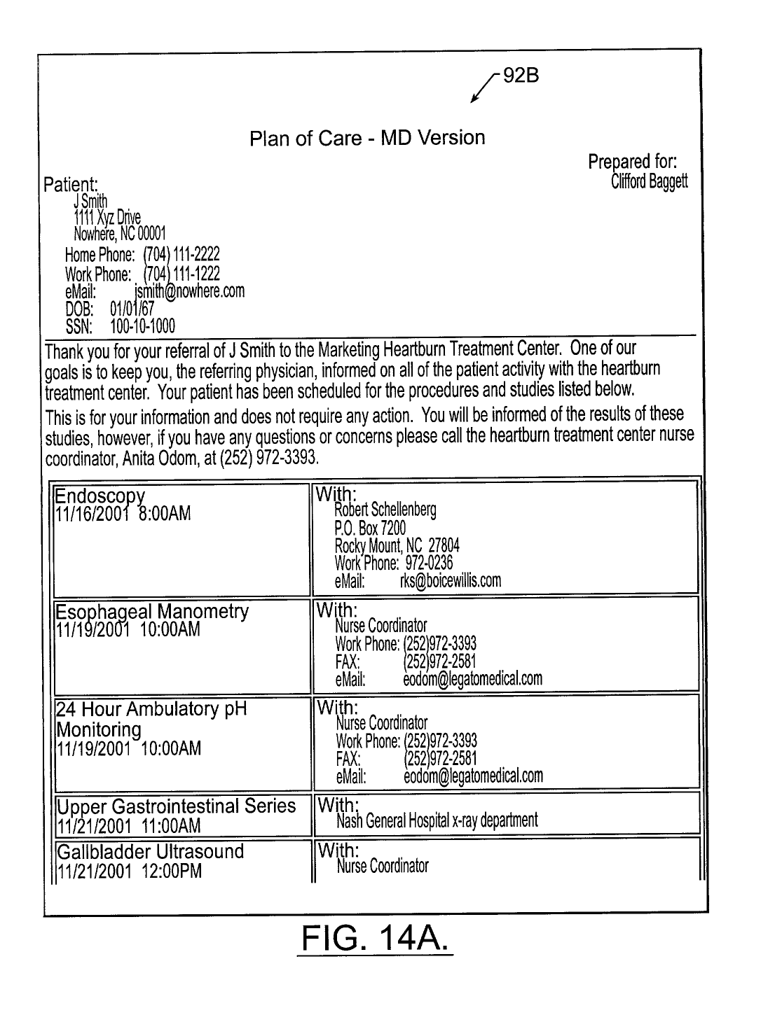

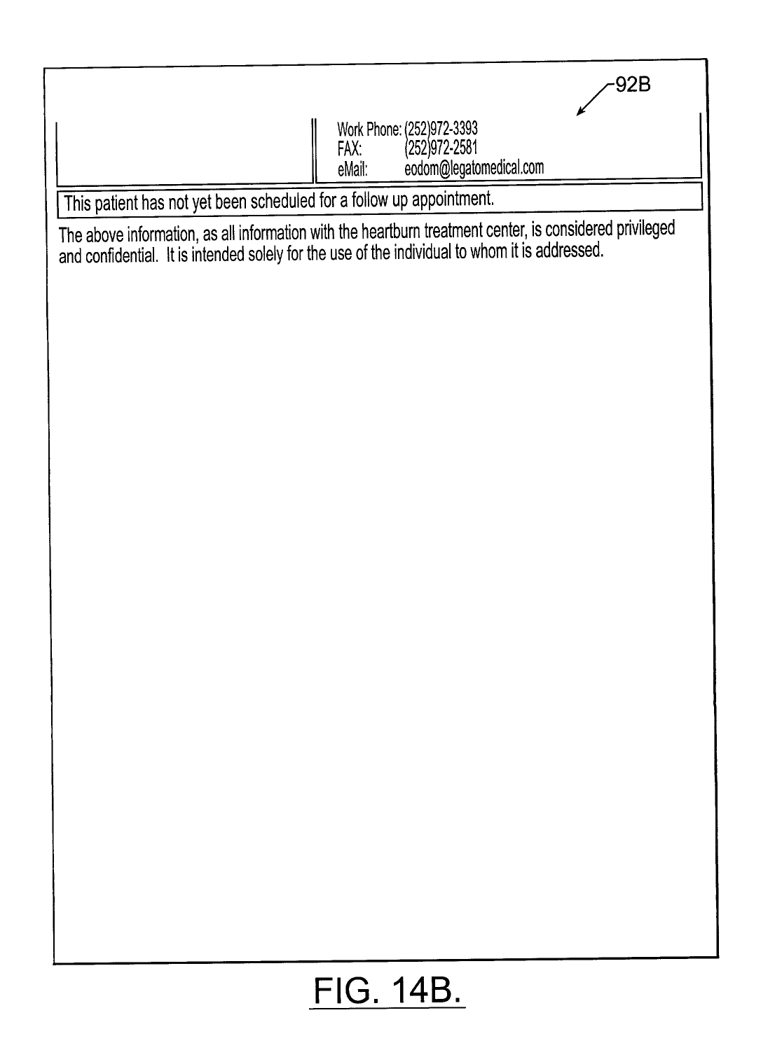

Referring again to FIG. 7, after all relevant diagnostic tests and the follow-up appointment have been scheduled, and all data related to the tests and appointment has been recorded and downloaded, the treatment process 60 proceeds to step 90, in which the coordinating party 14 uses the software program 20 to generate a patient plan of care 92A or a physician plan of care 92B. FIGS. 13A and 13B show a representative sample of a patient plan of care 92A for a typical patient 16. The patient plan of care 92A is downloaded to one of the databases 22 on the server 24 (see FIG. 2), and is then forwarded by the coordinating party 14 or otherwise made available to the patient 16. A representative sample of a physician plan of care 92B is shown in FIGS. 14A and 14B. Like the patient plan of care 92A, the physician plan of care 92B is downloaded to one of the databases 22 on the server 24 (see FIG. 2) and is then forwarded by the coordinating party 14 or otherwise made available to any PCP 18A, specialist 18E, or other selected healthcare providers involved in the treatment process 60.

Referring again to FIG. 8, the patient plan of care 92A and physician plan of care 92B are used as guides in executing step 94 of the treatment process 60. During step 94, all of the diagnostic tests that were scheduled as part of step 65 (see FIG. 7) are performed. As is set forth in step 96, after each test is performed, the coordinating party 14 contacts the healthcare provider 18 responsible for conducting the test and obtains the test results. Once the test results have been gathered, the coordinating party returns to the Web site 26, and enters the test results for each test on its respective appointment page by responding to customizable multiple-choice questions related to the test or by entering textual data into free-entry-text fields. For example, the appointment page 68 shown in FIG. 9 includes a series of questions regarding the results of the therapeutic endoscopy test. Each question is paired with a pull-down menu 100. The coordinating party 14 uses each pull-down menu 100 to select textual description data 102 representing the answer to the question appearing above the respective pull-down menu 100. Any revision made to the answers provided deselects the previous answer and selects the new answer chosen. After the results are entered, the coordinating party 14 saves the changes made to the appointment page 68 before entering other test result data.

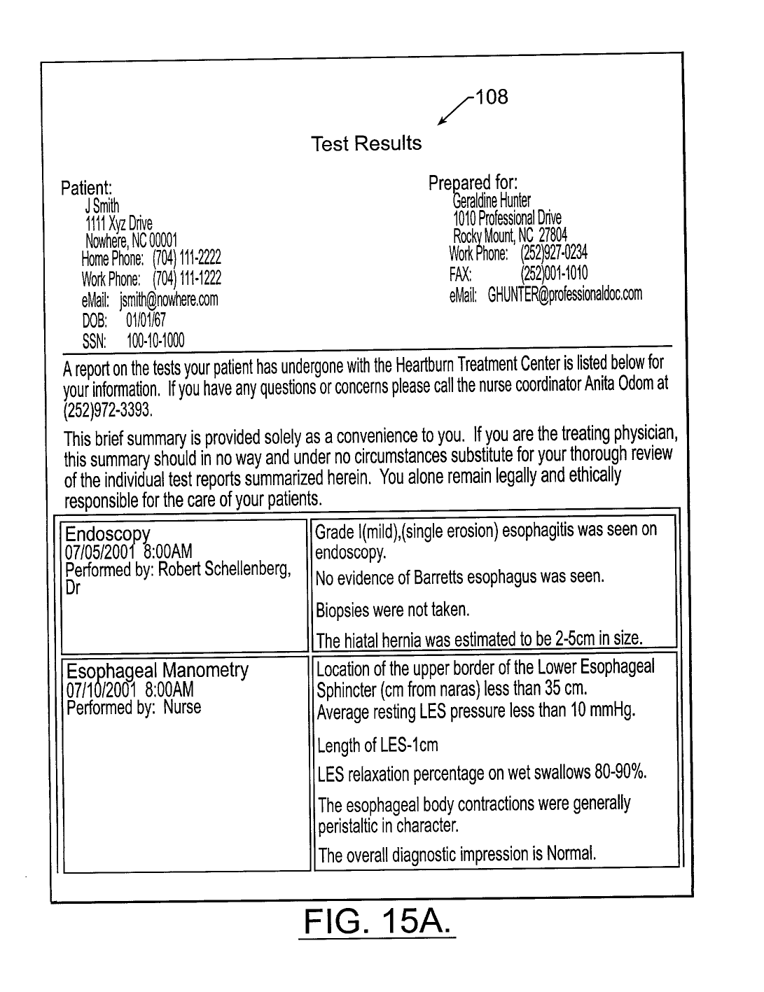

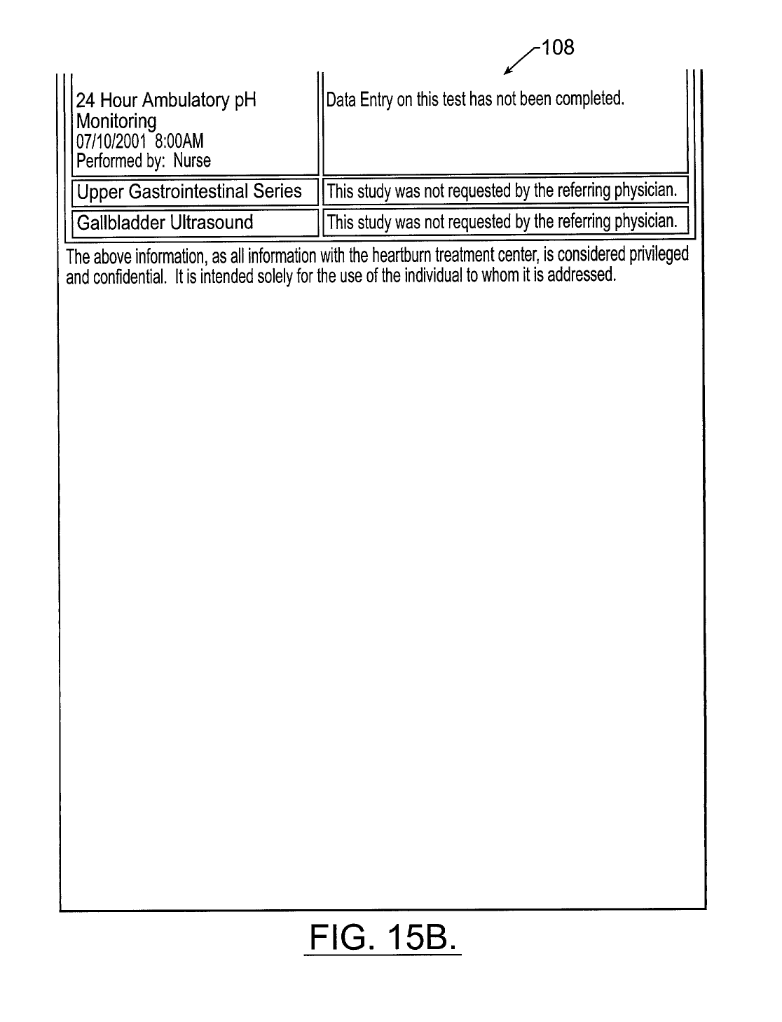

Referring again to FIG. 8, once all of the test results have been entered, the coordinating party 14 executes step 104 of the treatment process 60 by utilizing the software program 20 to publish a summary 108 of the test results for the patient 16. The summary 108 is downloaded to a database 22 on the server 24 (see FIG. 2) and is forwarded or otherwise made available to any PCP 18A, specialist 18E, or other selected healthcare providers involved in the treatment process 60. A representative sample of a summary 108 is shown in FIGS. 15A and 15B. The summary 108 is also used during the scheduled follow-up appointment which occurs as part of step 106 of the treatment process 60. During the follow-up appointment, the patient 16 and the PCP 18A or specialist 18E mutually decide upon a treatment track 109 for the patient 16. The treatment track 109 may include, but is not limited to non-surgical treatment 110, which may incorporate lifestyle changes and medications, an outpatient procedure 112 such as endoscopy, and/or an inpatient procedure 114 such as minimally invasive laparoscopic fundoplication.

The software program 20 includes a reminder feature that may be customized by the coordinating party 14 to alert the coordinating party 14 when date of the follow-up appointment for a particular patient has passed. This in turn prompts the coordinating party to execute step 116 of the treatment process 60, in which the coordinating party 14 contacts the PCP 18A or specialist 18E with whom the follow-up appointment was scheduled and confirms which treatment track 109 was selected.

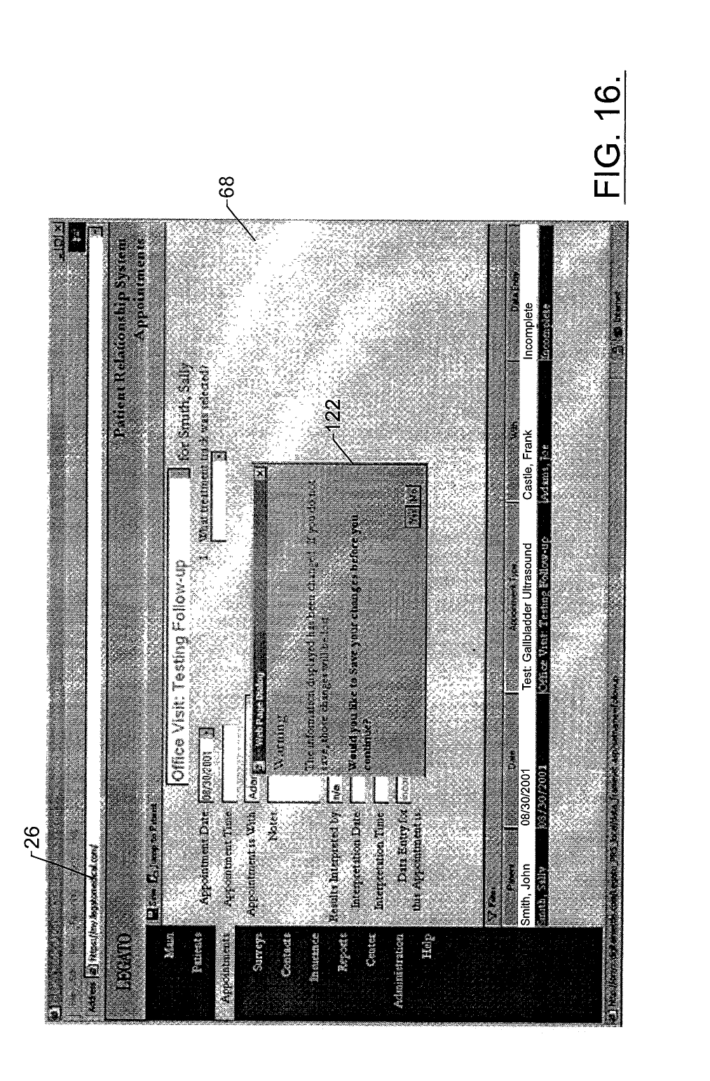

Referring again to FIG. 8, if endoscopy or a surgical procedure is planned, the coordinating party 14 collaborates with the specialist 18E to schedule the procedure for the patient 16, along with a post-operative appointment with the PCP 18A or specialist 18E (see step 118) The coordinating party 14 then returns to the Web site 26 and selects the appointment page 68 shown in FIG. 10 by highlighting and double-clicking on the appointment 82 for the patient 16 labeled “Office Visit: Testing Follow-up”, which causes the appointment page 68 corresponding to the follow-up appointment to open. Using a pull-down menu 120 that appears beneath textual data which reads “What treatment track was selected?”, the coordinating party 14 chooses textual data corresponding to the treatment track 109 that was chosen during the follow-up appointment. As is shown in FIG. 16, the software program 20 causes a warning window 122 to open that prompts the coordinating party 14 to save the changes made to the appointment page 68 before continuing to other areas of the Web site 26. An identical warning window 122 opens on any page of the Web site 26 that is revised to remind the coordinating party 14 to save all changes made (not shown).

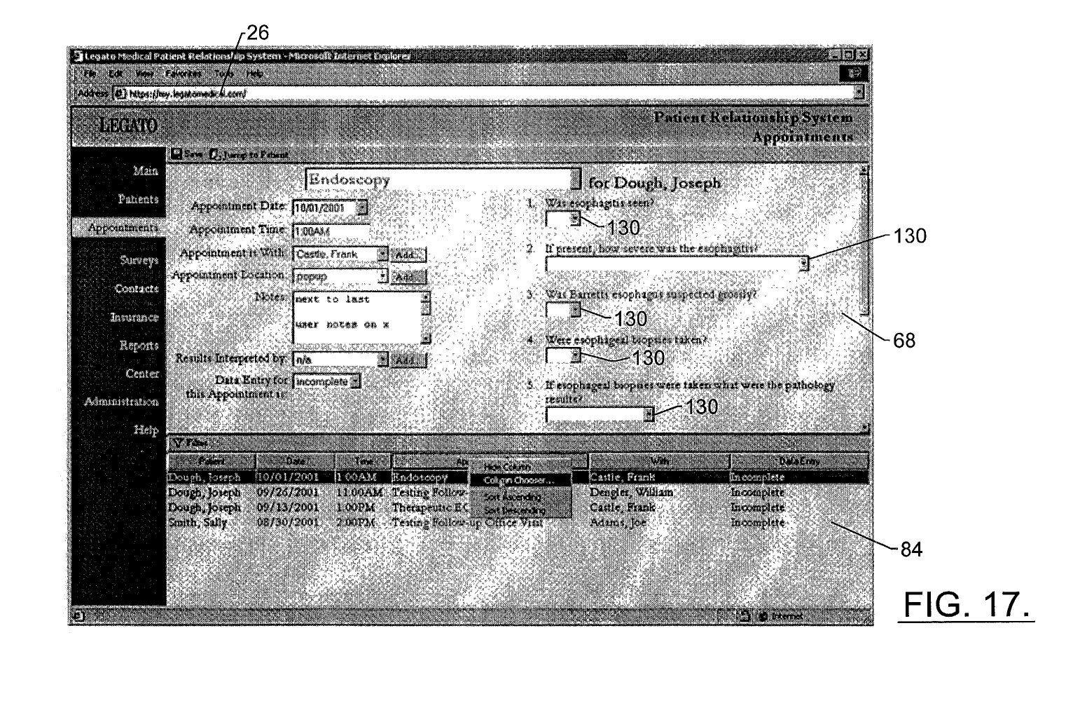

Referring now to FIG. 17, after revising the treatment track data, the coordinating party uses the software program 20 to create another appointment page 68 and adds the procedure corresponding to the treatment track 109 to the schedule 84 (See FIG. 8, step 124). The procedure is performed (See Id., step 126), and the post-operative appointment occurs (See Id., step 128). The coordinating party 14 collects all information relevant to the procedure and post-operative appointment, utilizes the software program 20 to enter the information into corresponding data entry fields 130 on the relevant appointment page 68, and downloads the data entered onto the server 24 (see FIG. 2).

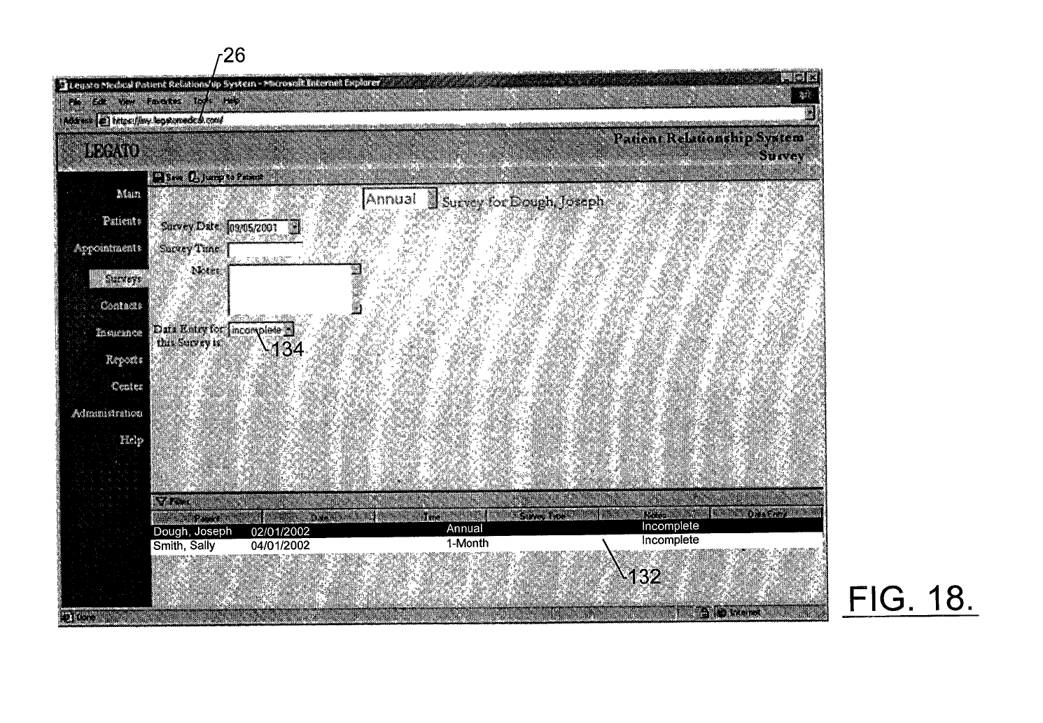

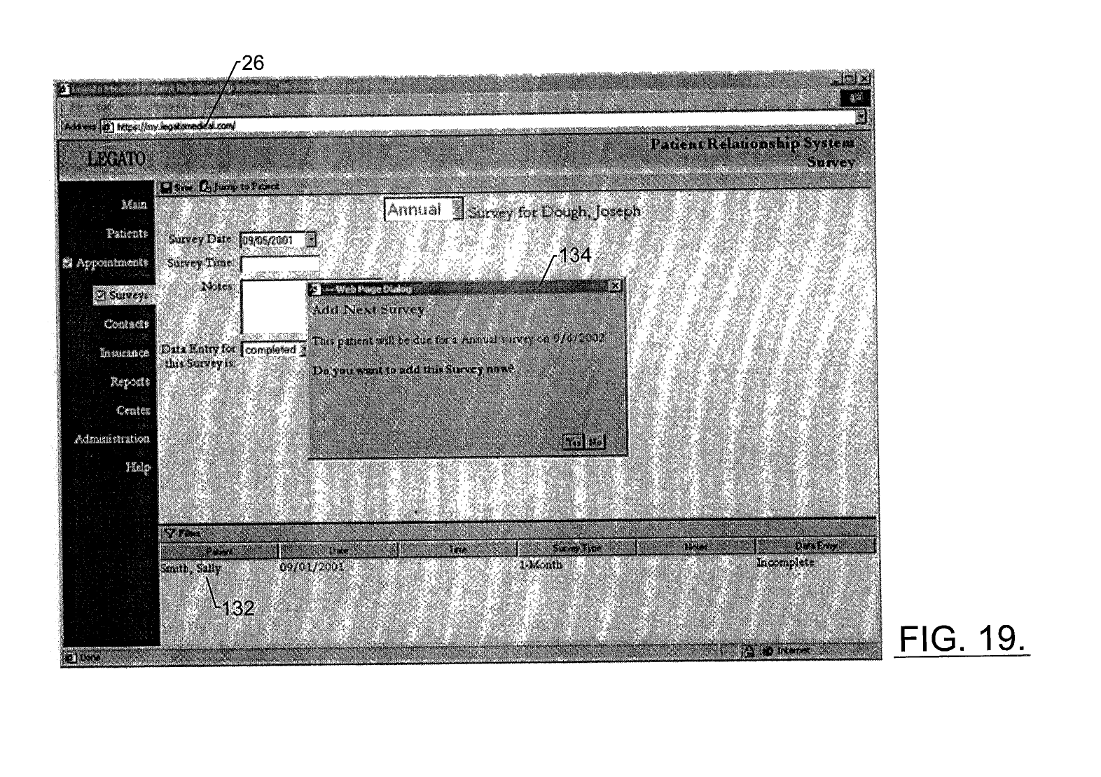

The treatment process 60 also incorporates the use of optional surveys to monitor the progress of the patient 16 after the treatment is completed (See Id., step 132). If an endoscopic or other surgical procedure was performed, the coordinating party 14 contacts the patient two weeks after the date of the procedure and has the patient 16 complete a multiple-choice questionnaire related to the specific procedure. If an endoscopic or other surgical procedure was not performed, the coordinating party 14 conducts the first survey at a predetermined time after the date of the follow-up appointment during which the treatment track 108 was selected. As is shown in FIG. 18, the software program 20 also permits the coordinating party 14 to create a survey schedule 132 which may include any number of customized reminders created by the coordinating party like the reminder 134 shown in FIG. 19 to prompt the coordinating party to conduct specific surveys on particular dates. Although any number of surveys may be conducted after the treatment process 60 is completed, a survey is preferably conducted two weeks, three months, and six months after treatment ends, and on an annual basis thereafter.

The system 10 of the present invention is not limited to the use of only one center 12. Alternate embodiments of the invention provide for multiple centers 12 staffed by respective coordinating parties 14 to use the treatment process 60 and Web-based software program 20 described above simultaneously. The software program 20 of the system 10 enables the system administrator 39 and coordinating party 14 to generate customized summary reports to one or more of such centers 12 for providing comparative data to the centers 12 regarding other centers 12 employing the system 10.

A computer-driven information management system has been disclosed. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

I claim:

1. A computer-driven information management system for coordinating delivery of healthcare services to patients via a communications network, comprising:
(a) a server including a database configured to receive and store for retrieval data representing information regarding a patient and collected by a coordinating party from an information source;
(b) data entry means for permitting said coordinating party to enter the data into the database;
(c) a computer communicating with the database via the communications network for processing the data using software downloaded to said server for permitting a requesting party selected from the group consisting of said coordinating party, the patient, a healthcare provider, and an individual authorized to access the data to use the data to coordinate a plan of care for the patient related to treatment of at least one medical condition; and
(d) a display device for displaying said data.

2. An information management system according to claim 1, wherein said communications network comprises a global communications network.

3. An information management system according to claim 1, wherein said plan of care comprises a preselected event selected from the group consisting of an appointment with a healthcare provider, an outpatient procedure, and an inpatient procedure.

4. An information management system according to claim 1 or 2, and including access means cooperating with the communications network for permitting said requesting party to access the data from a remote location.

5. An information management system according to claim 4, wherein said access means comprises a modem.

6. An information management system according to claim 5, wherein the access means further comprises a Web site maintained by a system administrator and accessible by the requesting party for permitting the requesting party to enter the data into and retrieve the data from the database using the software.

7. An information management system according to claim 6, wherein the access means further comprises a preselected password provided to the requesting party for selectively permitting the requesting party to access said Web site.

8. An information management system according to claim 1, wherein said coordinating party is selected from the group consisting of a healthcare provider and a registered nurse.

9. An information management system according to claim 1, wherein said information source is selected from the group consisting of the patient, the requesting party, and a healthcare provider.

10. An information management system according to claim 1, wherein said display means comprises a screen.

11. An information management system according to claim 10, wherein said screen comprises a VGA monitor.

12. An information management system according to claim 10, wherein said screen comprises an LCD screen.

13. An information management system according to claim 1, wherein said data entry means is selected from the group consisting of a keyboard and a graphical user interface including a touch screen.

14. A method of coordinating delivery of healthcare services to patients via a communications network, comprising:
(a) providing a computer-driven information management system including:
(i) a server including a database configured to receive and store for retrieval data representing information regarding a patient and collected by a coordinating party from an information source;
(ii) a data entry device for permitting said coordinating party to enter the data into the database;
(iii) a computer communicating with the database via the communications network for processing the data using software downloaded to said server for permitting a requesting party selected from the group consisting of said coordinating party, the patient, and an individual authorized to access the data to use the data to coordinate a plan of care for the patient related to treatment of at least one medical condition; and
(iv) a display device for displaying said data to said requesting party;
(b) collecting said information regarding the patient from said information source;
(c) entering the data representing the information collected from the information source into said database using said data entry device;
(d) using said computer to process the data using said software; and
(e) communicating the plan of care to the requesting party.

15. A method of coordinating delivery of healthcare services according to claim 14, wherein the communications network comprises a global communications network.

16. A method of coordinating delivery of healthcare services according to claim 14, wherein said plan of care comprises a preselected event selected from the group consisting of an appointment with a healthcare provider, an outpatient procedure, and an inpatient procedure for treating the medical condition.

17. A method of coordinating delivery of healthcare services according to claim 14 or 15, and including the step of providing said requesting party access to the data.

18. A method of coordinating delivery of healthcare services according to claim 16, wherein the step of providing the requesting party access to the data further comprises providing a modem cooperating with the communications network for permitting the requesting party to access the data from a remote location.

19. A method of coordinating delivery of healthcare services according to claim 16, wherein the step of providing the requesting party access to the data further comprises providing a Web site maintained by a system administrator and accessible by the requesting party for permitting the requesting party to enter the data into and retrieve the data from the database using the software.

20. A method of coordinating delivery of healthcare services according to claim 18, wherein the step of providing the requesting party access to the data further comprises providing a preselected password to the requesting party for selectively permitting the requesting party to access said Web site.

21. A method of coordinating delivery of healthcare services according to claim 14, wherein said coordinating party is selected from the group consisting of a healthcare provider and a registered nurse.

22. A method of coordinating delivery of healthcare services according to claim 14, wherein said information source is selected from the group consisting of the patient, the requesting party, and a healthcare provider.

23. A method of coordinating delivery of healthcare services according to claim 14, wherein said display means comprises a screen.

24. A method of coordinating delivery of healthcare services according to claim 22, wherein said screen comprises an LCD screen.

25. A method of coordinating delivery of healthcare services according to claim 22, wherein said screen comprises a VGA monitor.

26. A method of coordinating delivery of healthcare services according to claim 14, wherein said data entry means is selected from the group consisting of a keyboard and a graphical user interface including a touch screen.

27. A computer readable medium including software for coordinating delivery of healthcare services to a patient for treatment of at least one medical condition, said software comprising instructions for:
(a) configuring a database located on a server to receive and store for retrieval data representing information regarding a patient and collected by a coordinating party from an information source;
(b) associating a data entry device with said database for permitting said coordinating party to enter the data into the database; and
(c) associating a computer with said data entry device and the database for processing the data, thereby permitting a requesting party selected from the group consisting of said coordinating party, the patient, and an individual authorized to use the data to coordinate a plan of care for the patient related to treatment of at least one medical condition;
(d) enabling said computer to cooperate with a communications network for permitting said requesting party to access the plan of care from a remote location; and
(e) enabling a display device associated with the computer to display the data to the requesting party.

28. A computer-driven information management system for coordinating delivery of healthcare services to patients via a communications network, comprising:
(a) a server including a database configured to receive and store for retrieval data representing information regarding a patient and collected by a coordinating party from an information source;
(b) a data entry device for permitting said coordinating party to enter the data into the database;
(c) a computer communicating with the database via the communications network for processing the data using software downloaded to said server for permitting a requesting party selected from the group consisting of said coordinating party, the patient, a healthcare provider, an individual authorized to access the data to use the data to coordinate a plan of care for the patient related to treatment of at least one medical condition; and
(d) a display device for displaying said plan of care to said requesting party.
